(19) United States
(12) Patent Application Publication
(10) Pub. No.: US 2016/0029861 A1
(43) Pub. Date: Feb. 4, 2016

(54) MOUNTING METHOD AND APPARATUS

(71) Applicant: CROYDEX LIMITED, Andover Hampshire (GB)

(72) Inventors: Peter James Harold Pegden, East Yorkshire (GB); Paul Edward Wills, Andover Hampshire (GB)

(73) Assignee: Croydex Limited, Andover Hampshire (GB)

(21) Appl. No.: 14/774,922

(22) PCT Filed: Mar. 10, 2014
(86) PCT No.: PCT/GB2014/050699

§ 371 Date: Sep. 11, 2015

(30) Foreign Application Priority Data
Mar. 13, 2013 (GB) 1304506.7

(51) Int. Cl. A47K 13/26; C09J 5/00; A47K 13/12

(52) U.S. Cl. CPC A47K 13/26; A47K 13/12; C09J 5/00

(57) ABSTRACT

The invention provides a method and apparatus for mounting a toilet seat to a toilet pan, the characteristic feature being that, in addition to being clamped to the pan in the conventional manner, the seat hinge is adhered to the pan to prevent sliding movement of the hinge relative to the pan.

### FIELD OF THE INVENTION

This invention provides a method of and/or apparatus for mounting a toilet seat on a toilet pan.

### BACKGROUND TO THE INVENTION

A toilet seat is typically fixed to a toilet pan by way of two spaced hinges fixed to spaced positions on or adjacent to the rear edge of the seat. One part of each hinge is secured to the seat and the other part of each hinge is secured to the pan. That part of the hinge attached to the pan is typically fixed by passing a threaded rod or shaft through a vertical hole extending downwards from the top face of the pan, and then applying a locking nut to that part of the rod or shaft that projects from the opposite end of the hole.

A problem that arises from this arrangement is that the holes in the pan are invariably larger in diameter than the diameters of the fixing rods or shafts and, over time and while being subjected to working loads, the rods displace relative to the axes of the holes in the pan, the locking nuts work loose and the toilet seat thus moves with respect to the pan.

Various methods have been adopted, in the past, to reduce the problem. One common method involves positioning rubber or plastics washers between the hinges and the pan but this solution has limited effectiveness for a number of reasons. Firstly the materials from which the washers are formed deteriorate with time. Further, they deteriorate with exposure to a number of toilet cleaning chemicals. Thirdly toilet pans are generally formed from vitreous enamel which has a very smooth, low friction surface. As a result, once tension on the fixing rods lessens, the washers can slide freely over the surface of the pan.

It is an object of the invention to provide a method and apparatus which will go at least some way in addressing the drawbacks mentioned above; or which will at least provide a novel and useful alternative.

### SUMMARY OF THE INVENTION

Accordingly, in one aspect, the invention provides a method of mounting a toilet seat hinge on a toilet pan, said toilet seat hinge including a hinge base and a fixing rod locatable through a hole in said pan, said method comprising using an adhesive between said hinge base and said pan to prevent sliding movement between said hinge base and said pan.

Preferably said method includes providing said adhesive so as to encircle said hole.

Preferably said adhesive is applied to a locating component or grip gasket located between said hinge base and said pan.

Preferably said method further includes locking the position of said grip gasket relative to said pan by engaging a locking component with said grip gasket, and fixing said locking component to said pan.

Preferably said method comprises adhering said locking component to said pan whilst said locking component is engaged with said grip gasket.

Preferably said method further includes first effecting a trial assembly of said hinge base on said pan to determine a desired position of said hinge base relative to said pan; and fixing a demountable template to said pan to indicate said desired position.

In a second aspect the invention provides apparatus for mounting a toilet seat hinge on a toilet pan, said hinge having a hinge base and a fixing rod locatable, in use, through a hole in said pan, said apparatus including a locating component having a surface for adhesive engagement with said pan and being engageable with said hinge base to prevent sliding movement of said hinge base with respect to said pan.

Preferably said locating component comprises a grip gasket, said grip gasket further including surfaces configured to engage complimentary surfaces on said hinge base. In one embodiment said complimentary surfaces are on an external part of said hinge base and, in another embodiment, are on an internal part of said hinge base.

Preferably said grip gasket further includes an aperture through which, in use, said fixing rod may pass.

Preferably said surface for adhesive engagement with said pan include one or more recesses to retain an adhesive compound. Parts of said one or more recesses may extend through said locating component.

Preferably said apparatus further includes a locking component, said locking component being engageable between said locating component and said pan.

Preferably said locking component is configured for physical engagement with said locating component and adhesive engagement with said pan.

In a third aspect the invention provides a method of adapting the mounting of a toilet seat to a toilet pan, said seat being mounted on said pan by way of two hinges, each hinge including a hinge base and a fixing rod extending from said hinge base through a hole provided in said pan, said method including inserting a locating component between said hinge base and said pan, and adhering said locating component to said pan.

Many variations in the way the invention may be performed will present themselves to those skilled in the art, upon reading the following description. The description should not be regarded as limiting but rather as an illustration, only, of one manner of performing the invention. Where appropriate any element or component should be taken as including any or all equivalents thereof whether or not specifically mentioned.

### BRIEF DESCRIPTION OF THE DRAWINGS

Working embodiments of the invention will now be described with reference to the accompanying drawings in which:

FIG. 1: shows a plan view of a toilet pan to which the method and apparatus of the invention may be applied;

FIG. 2: shows a side elevation of a toilet pan;

FIG. 3: shows an enlarged view of part of that which is shown in the area circled in FIG. 2;

FIG. 4: shows an exploded view of one embodiment of mounting apparatus according to the invention that is fixed in the general manner shown in FIG. 3;

FIG. 5: shows an exploded view of second embodiment of mounting apparatus according to the invention; and

FIG. 6: shows an exploded view of a third embodiment of mounting apparatus according to the invention.

### DETAILED DESCRIPTION OF WORKING EMBODIMENT

This invention provides a method of, and/or apparatus for mounting a toilet seat on a toilet pan or bowl, the objective being to minimize the possibility of the seat becoming loose on the pan. In their broadest forms the method and apparatus described herein address this objective by providing an adhesive bond between the seat hinge, and the pan, to supplement the conventional tensioned rod fixings and, more particularly, to prevent sliding movement between the hinges and the pan. This has the added benefit of reducing sideways loading on the fixing rods which, in existing installations, leads to loosening of the fixings.

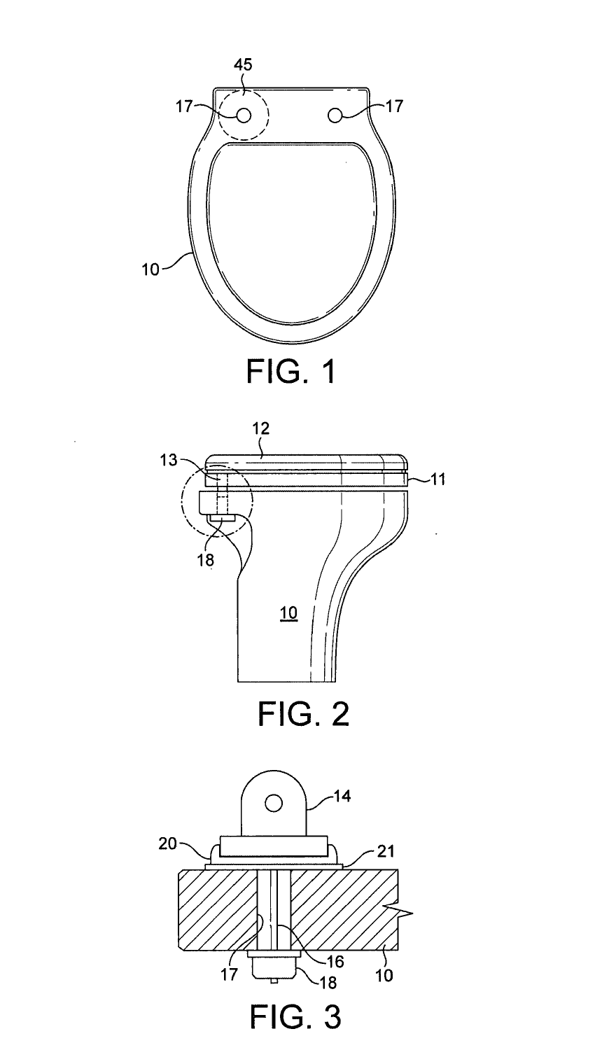

Referring to FIGS. 1 to 3, a toilet pan 10 is shown. A toilet seat 11 and lid 12 are fitted to the pan by way of hinges 13, one of which can be seen in FIGS. 2 and 3. Conventionally each hinge 13 comprises a hinge base 14 fixed to the pan that, in a number of alternative ways, forms a hinged connection with the seat 11. The hinge base 14 is fixed to the pan by a screw or rod 16 that attaches at one end to the hinge base, passes through a hole 17 in the pan 10, and is retained at its distal end by a locking nut 18.

The application of the invention to the hinge arrangement described varies according to the configuration of the hinge. Existing hinge configurations may be adapted by the provision of an adhesive locating component or grip gasket; or bespoke hinge configurations may be produced that include an adhesive surface to engage the toilet pan.

As can be seen from FIG. 3 grip gasket 20, when provided, is fixed to the pan by a layer 21 of adhesive and physically engages with the hinge base 14. In this way the hinge base 14 is restrained against sliding movement with respect to the pan 10. The grip gasket 20 preferably underlies substantially the entire plan surface of the hinge base 14 and thus ensures an adhesive bond between the hinge base and the pan that surrounds the hole 17.

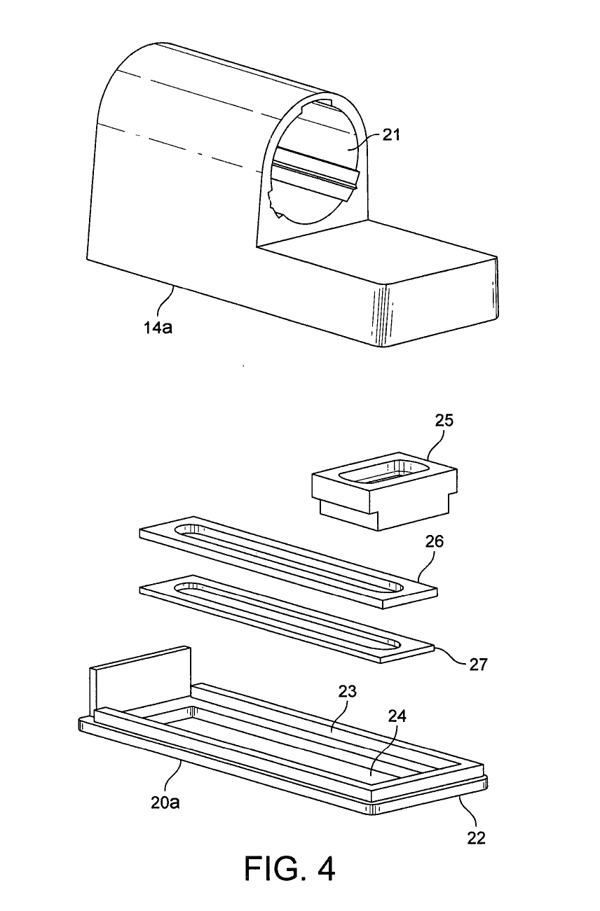

Turning now to FIG. 4, hinge base 14a proves part of what is known as a soft close toilet seat hinge. Axle pins (not shown) engage in facing bores 21, the pins then engaging in bores or fittings attached to opposite edges of the seat.

The hinge base 14a is fixed on to the seat pan via a grip gasket 20a, the underside 22 of the grip gasket being adhered to the upper surface of the pan. The grip gasket further includes a peripheral lip 23 that engages the lower vertical edges of the hinge base 14a to physically restrain the hinge base relative to the pan, and a central aperture 24 through which fixing rod 16 may pass to secure the hinge base 14a in position. Rod 16 is retained in the hinge base 14a by a grip washer 25 which, in turn, is a horizontal sliding fit within the hinge base 14a.

In order to maintain the position of the grip gasket 20a while the adhesive cures, a locking component 26 is preferably provided which, in the form shown, fits within the central aperture 24 of the grip gasket so as to engage the edges defining aperture 24, and is also adhered to the pan 10. Both the grip gasket 20a and the locking component 26 are preferably ABS mouldings but could equally be formed from other plastics or metals. The underside 22 of the grip gasket may be provided with channels (not shown) to receive the adhesive 21 whilst the locking component may be fixed into position by a correspondingly shaped section 27 of double-sided adhesive tape.

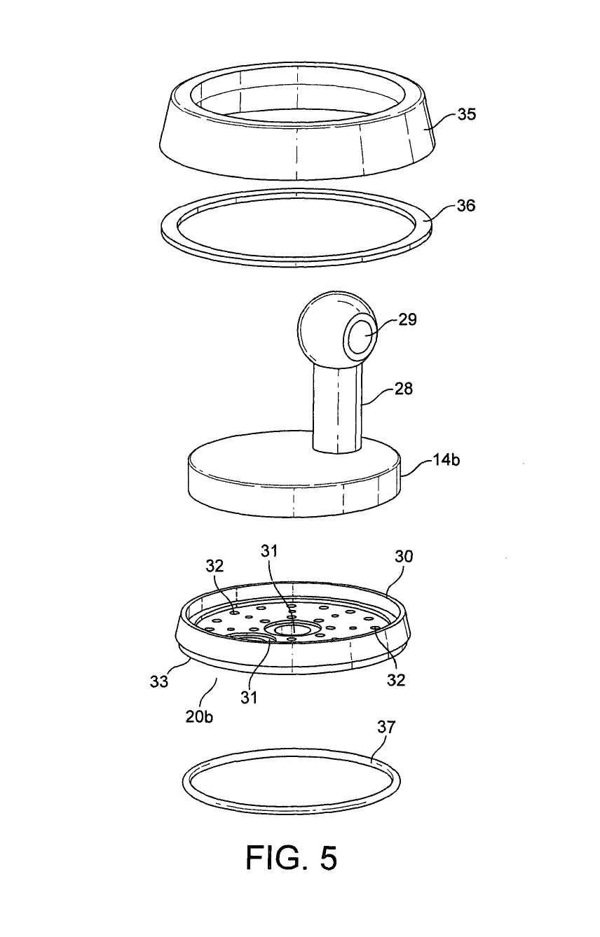

Referring now to FIG. 5, an alternative embodiment of mounting apparatus is shown, again largely using known components. Hinge base 14b is shown having an upstanding post 28 that includes horizontal bores 29 for mounting the seat 11. As with the embodiment just described, a grip gasket 20b is mounted between the hinge base 14b and the pan, the hinge base 14b being clamped to the pan by rod 16 (not shown in this embodiment).

In the embodiment shown in FIG. 5, the grip gasket 20b is a substantially circular disc having a peripheral lip 30 that locates against the circular outer surface of the hinge base 14b. The grip gasket also has a plurality of through holes 31 through one of which the fixing rod 16 may pass, and preferably a plurality of smaller through holes 32 through which glue used to adhere the underside 33 of the grip gasket to the pan, may extrude. The underside 33 preferably includes channels (not shown) to receive the glue and the through holes 32 preferably extend between those channels and the upper surface of the grip gasket 14b as is visible in FIG. 5.

Also shown in FIG. 5 is a locking component 35 that fits around the periphery of the grip gasket and is fixed to the pan by section 36 of double sided tape. As with the previous embodiment the locking component 35 fixes the position of the grip gasket 20b whilst the adhesive 21 cures and, in this embodiment, an O-ring 37 is preferably provided to seal between the locking component and the adhesive to prevent leakage of the adhesive 21 before it is cured, and to prevent external fluids contacting the adhesive.

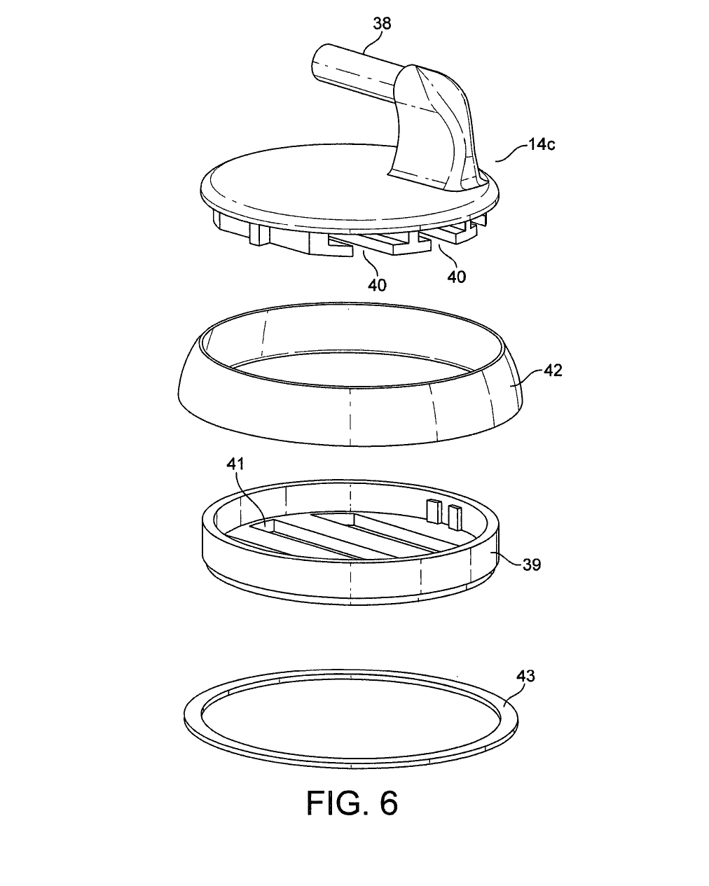

Turning now to FIG. 6 a further embodiment of hinge is shown that is very similar to that shown in FIG. 5 but in this embodiment hinge base 14c is provided with a horizontally extending pin 38 to mount the seat 11. Another feature of this embodiment is that existing hinge base plate 39 provides the function of the grip gasket and is adhered to the pan by adhesive 21 as shown in FIG. 3.

As can be seen, the hinge base 14c includes a variety of retaining channels 40 in the underside thereof to retain the head of fixing rod 16 while the base plate 39 includes slotted apertures 41 through which the rod 16 may pass to engage the pan 10 in the conventional manner described above.

In order to fix the position of the hinge base plate 39 while the adhesive 21 cures, locking component 42 is provided which engages about the outer surface of the base plate 39 and is fixed to the pan 10 by a section 43 of double sided tape. Again an O-ring (not shown) may be provided about the joint between the base plate 39 and the pan to retain the adhesive before curing, and to prevent fluids coming into contact with the adhesive after curing.

In use, the hinge bases 14, 14a, 14b , or base plates 39, are preferably trial fitted to establish the positions that will result in the desired or optimal position of the seat relative to the pan. Once the desired or optimal positions have been established, a template (45 in FIG. 1) whose internal shape corresponds to the hinge base 14a or locking component 35 or 42, as the case may be, is taped into position and the hinge components removed. Thereafter the hinge bases are secured into position relative to the templates by gluing the grip gaskets or the hinge bases, and then fixing the locking components in position.

Once the fixing rods have been tightened it will be appreciated that the hinges are not just restrained against vertical movement as in the conventional manner, but are also restrained against sliding movement relative to the pan surface on which they are mounted. This additional restraint reduces the bending or twisting loads applied to the fixing rods and thus reduces the likelihood of the hinges working loose. As a result a long-experienced problem has been addressed if not overcome.

1. A method of mounting a toilet seat hinge on a toilet pan, said toilet seat hinge including a hinge base and a fixing rod locatable through a hole in said pan, said method comprising using an adhesive between said hinge base and said pan to prevent sliding movement between said hinge base and said pan.

2. A method as claimed in claim 1, including providing said adhesive so as to encircle said hole.

3. A method as claimed in claim 1, wherein said adhesive is applied to a locating component or grip gasket, located between said hinge base and said pan.

4. A method as claimed in claim 3, further including locking the position of said grip gasket relative to said pan by engaging a locking component with said grip gasket, and fixing said locking component to said pan.

5. A method as claimed in claim 4, comprising adhering said locking component to said pan whilst said locking component is engaged with said grip gasket.

6. A method as claimed in claim 1 further including first effecting a trial assembly of said hinge base on said pan to determine
a desired position of said hinge base relative to said pan; and fixing a demountable template to said pan to indicate said desired position.

7. An apparatus for mounting a toilet seat hinge on a toilet pan, said hinge having a hinge base and a fixing rod beatable, in use, through a hole in said pan, said apparatus including a locating component having an surface for adhesive engagement with said pan and being engageable with said hinge base to prevent sliding movement of said hinge base with respect to said pan.

8. An apparatus as claimed in claim 7, wherein said locating component comprises a grip gasket, said grip gasket further including surfaces configured to engage complimentary surfaces on said hinge base.

9. An apparatus as claimed in claim 8, wherein said complimentary surfaces are on an external part of said hinge base.

10. An apparatus as claimed in claim 8, wherein said complimentary surfaces are on an internal part of said hinge base.

11. An apparatus as claimed in claim 8, wherein said grip gasket further includes an aperture through which, in use, said fixing rod may pass.

12. An apparatus as claimed in claim 7, wherein said surface for adhesive engagement with said pan includes one or more recesses to retain an adhesive compound.

13. An apparatus as claimed in claim 12, wherein parts of said one or more recesses may extend through said locating component.

14. An apparatus as claimed in claim 7, further including a locking component, said locking component being engageable between said locating component and said pan.

15. An apparatus as claimed in claim 14, wherein said locking component is configured for physical engagement with said locating component and adhesive engagement with said pan.

16. A method of adapting the mounting of a toilet seat to a toilet pan, said seat being mounted on said pan by way of two hinges, each hinge including a hinge base and a fixing rod extending from said hinge base through a hole provided in said pan, said method including inserting a locating component between said hinge base and said pan, and adhering said locating component to said pan.
